(19) United States
(12) Patent Application Publication
(10) Pub. No.: US 2010/0272098 A1
(43) Pub. Date: Oct. 28, 2010

(54) METHOD AND SYSTEM FOR VOIP PBX CONFIGURATION

(76) Inventors: Scott Ferguson, Wellington Point (AU); Russell Tweed, Wellington Point (AU)

Correspondence Address: ETHERTON LAW GROUP, LLC, 2010 E. University Drive, Suite 25, Tempe, AZ, 85281, US

(21) Appl. No.: 12/768,619

(22) Filed: Apr. 27, 2010

(30) Foreign Application Priority Data
Apr. 28, 2009 (AU) 2009901839

(51) Int. Cl. H04L 12/66

(52) U.S. Cl. 370/352

(57) ABSTRACT

A VOIP PBX configuration system and method enable remotely configuring a VOIP PBX server connected to the Internet. The system includes a central server connected to the Internet and having a database of VOIP PBX configuration templates. The central server is accessible via a website user interface having configuration fields to be populated by a user. The central server includes computer readable program code components configured to modify the configuration templates to generate configuration instructions based on user entries in the configuration fields, and transmit the configuration instructions to the VOIP PBX server to configure the VOIP PBX server based on the user entries.

### FIELD OF THE INVENTION

The present invention relates to a voice over internet protocol (VOIP) private branch exchange (PBX) configuration system. In particular, although not exclusively, the invention relates to a method and system for a remote VOIP PBX configuration.

### BACKGROUND TO THE INVENTION

Voice over internet protocol (VOIP) is a transmission technology that enables voice signals to be transmitted over the Internet or other packet-switched networks. Thus VOIP signals can be transmitted through either wired or wireless mediums. Because VOIP systems can generally interface with conventional public switched telephone networks (PSTNs), VOIP systems are versatile and are becoming widely used for conventional telephonic communications. Many cost-conscious organizations are adopting VOIP technology to enable the efficient deployment of a local area telephone network including a private branch exchange (PBX) at a cost significantly lower than that of conventional copper-wire telephone systems.

A PBX is a local telephone exchange that serves a particular area such as a building or office complex. Using extension lines, a PBX generally interconnects the internal telephones of an organization to each other and to a public switched telephone network (PSTN). Through the PBX, calls can thus be placed from an internal extension to other internal extensions or to external lines. A VOIP PBX, also known as an IPBX, enables an organization to obtain the benefits of a PBX using existing Internet access and very low cost modern hardware.

However, installing and managing VOIP PBX systems can be complicated, and specialised technicians are generally required to install and manage new VOIP PBX apparatus, and configure the VOIP PBX for a user specific dial plan. Therefore, there is a need for an improved method and system for VOIP PBX configuration.

### OBJECT OF THE INVENTION

An object of the present invention is to overcome or alleviate one or more limitations of the prior art including providing an improved method and system for VOIP PBX configuration.

### SUMMARY OF THE INVENTION

In one form, although it need not be the only or indeed the broadest form, the invention resides in a VOIP PBX configuration system for remotely configuring a VOIP PBX server connected to the internet, the VOIP PBX configuration system comprising:

a central server connected to the internet and having a database of VOIP PBX configuration templates, the central server being accessible via a website user interface having configuration fields to be populated by a user; the central server being configured to modify the configuration templates to generate configuration instructions based on entries in the configuration fields; and the server being operable to transmit the configuration instructions to the VOIP PBX server to configure the VOIP PBX server based on the user entries.

Preferably, the configuration fields include any one of the following: VOIP main number and password, and Direct Inward Dialling Number sequence.

Preferably, the configuration instructions are in the form of a command list which is built from one of the templates and the populated configuration fields.

Preferably, the central server is operable to test that the VOIP PBX server is live before the command list is transmitted to the VOIP PBX server.

The configuration fields may include more than one VOIP number.

### BRIEF DESCRIPTION OF THE DRAWINGS

To assist in understanding the invention and to enable a person skilled in the art to put the invention into practical effect, preferred embodiments of the invention are described below by way of example only with reference to the accompanying drawings, in which:

FIG. 1 is a schematic diagram of a VOIP PBX system and a VOIP PBX configuration system in accordance with the invention.

FIG. 2 is an illustration of a screen shot of a Server Details web page.

FIG. 3 is an illustration of a screen shot of a web page that is displayed when a check network test is successfully completed.

FIG. 4 is an illustration of a screen shot of a Backup/Restore web page.

FIG. 5 is an illustration of a screen shot of a dialog box.

FIG. 6 is an illustration of a screen shot of a New Business Plan Entry web page used to receive new business plan data.

FIG. 7 is an illustration of a screen shot of a Server Detail web page that is displayed after the submit button is clicked on the New Business Plan Entry web page.

FIG. 8 is an illustration of a screen shot of a Detect Handsets web page.

FIG. 9 is an illustration of a screen shot of a Program Handsets web page.

FIG. 10 is a block diagram illustrating components of a central server that can configure a VOIP PBX server.

Those skilled in the art will appreciate that minor deviations from the symmetrical layout of components as illustrated in the drawings will not detract from the proper functioning of the disclosed embodiments of the present invention.

### DETAILED DESCRIPTION OF THE INVENTION

One embodiment of the present invention comprises a remote VOIP PBX server and a central server connected to the Internet, the central server being accessible via a website user interface and operable to send configuration instructions to the VOIP PBX server to configure the VOIP PBX server based on user entries into the website user interface. Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

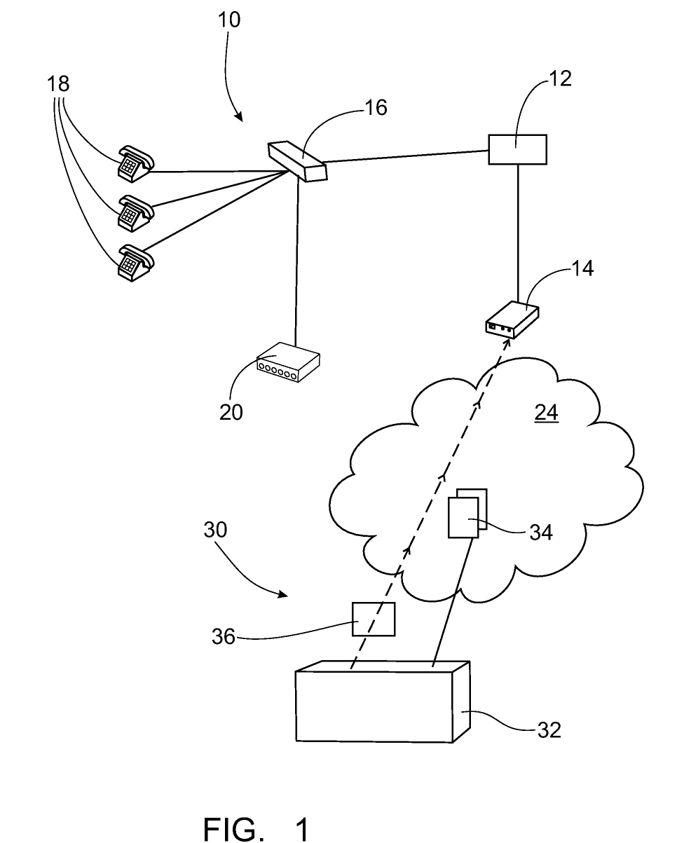

Referring to FIG. 1, a VOIP PBX system 10 comprises a VOIP PBX server 12, a broadband modem 14 (such as an asymmetric digital subscriber line (ADSL) modem) connected to the VOIP PBX server 12, a network switch 16 connected to the VOIP PBX server 12, a plurality of telephone handsets 18 and a public switched telephone network (PSTN) gateway 20 connected to the switch 16.

The VOIP PBX server 12 is a standard commercially available VOIP PBX server. The VOIP PBX server 12 is connected to the Internet 24 through the broadband modem 14. The internet connection allows the VOIP PBX server 12 to handle incoming and outgoing VOIP calls, which are routed to the handsets 18 via the switch 16. The switch 16 is also connected to the PSTN gateway 20 as a backup.

A VOIP PBX configuration system 30, according to one embodiment of the present invention, comprises a central server 32 connected to the Internet 24. The central server 32 is accessible via a website user interface in the form of web pages 34. The central server 32 can communicate with the VOIP PBX server 12 via the Internet 24. A user of the VOIP PBX system 10 can configure the VOIP server 12 by populating required configuration fields in a web page 34 that is hosted by the central server 32. The web pages 34 can be displayed on a display screen of any computer (not shown) that has access to the Internet 24.

After receiving the configuration information, the central server 32 is able to automatically configure the VOIP PBX server 12. The central server 32 includes a database of VOIP PBX configuration templates, which are copied and then modified depending on the entries provided by a user in the fields of the web page 34 to generate configuration instructions in the form of a command list 36. The command list 36 is then sent to the VOIP PBX server 12 to configure the VOIP PBX server 12 with a customized dial plan based on the user entries into the configuration fields.

When a user/administrator first attempts to configure the VOIP PBX system 10, the components shown in FIG. 1 first need to be connected together. For example, the VOIP PBX system 10 may be delivered to a user in the form of a kit. The kit may include the VOIP PBX server 12, the broadband modem 14, the handsets 18, the switch 16, category 5 (CAT5) cable, and subscriber identity module (SIM) cards. The user then connects the hardware by, for example, connecting the “LAN1” port on the VOIP PBX server 12 to the broadband modem 14 using a CAT5 cable. The “LAN2” port on the VOIP PBX server 12 is connected to the network switch 16 using a CAT5 cable, each of the handsets 18 is connected to the network switch 16 using a CAT5 cable, and a SIM card is inserted into a universal serial bus (USB) port of the broadband modem 14. Finally, the network switch 16 is connected to the PSTN gateway 20 using a CAT5 cable.

After the above connections are made, the equipment is powered on in an appropriate order. For example, the broadband modem 14 is powered on first, then the VOIP PBX server 12 and the network switch 16. The handsets 18 are powered on last.

Next, the user/administrator logs on to a web site hosted by the central server 32. A detailed description of examples of various web pages 34 used to interact with a user/administrator of the VOIP PBX server 12 is provided below.

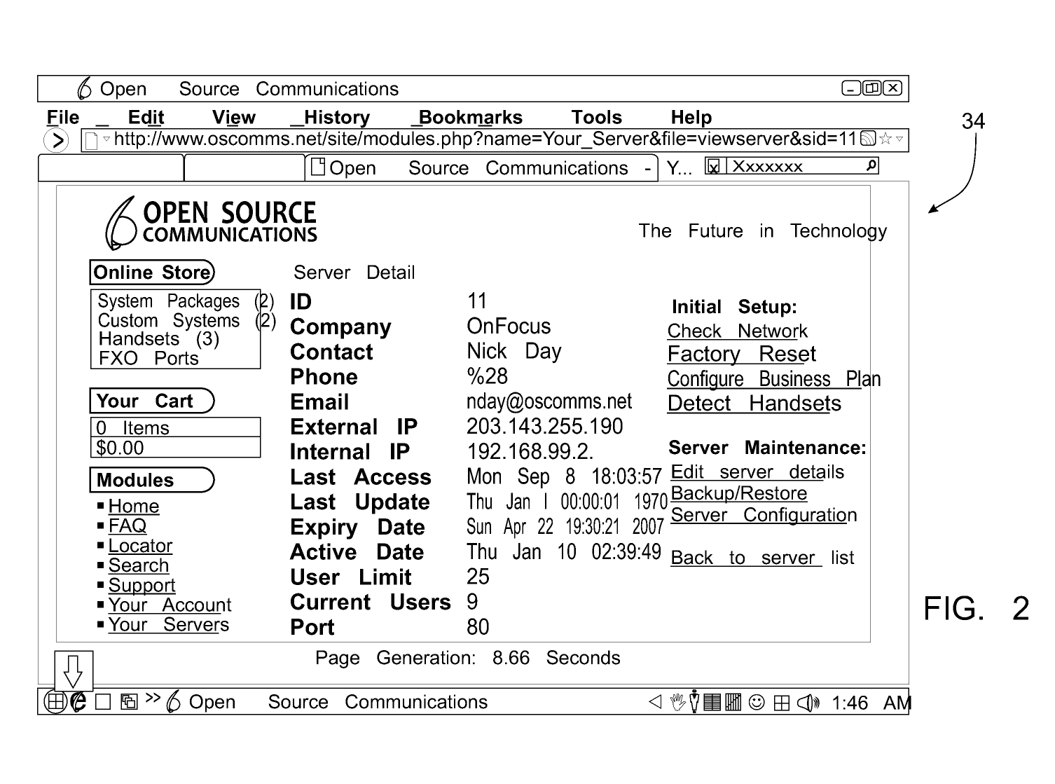

FIG. 2 is an illustration of a screen shot of a Server Details web page. Under “Initial Setup:” the user/administrator clicks on “Check Network” to initiate a test of the connection with the Internet to ensure that the connection with the broadband modem 14 is able to handle VOIP signals. The check network test may include transmitting test packets to the client host and recording average response latency. A connection to a control port is then opened on the client host and an “are you alive” request is transmitted to the host. Finally, a request for a server ID and subscription details are requested from the host.

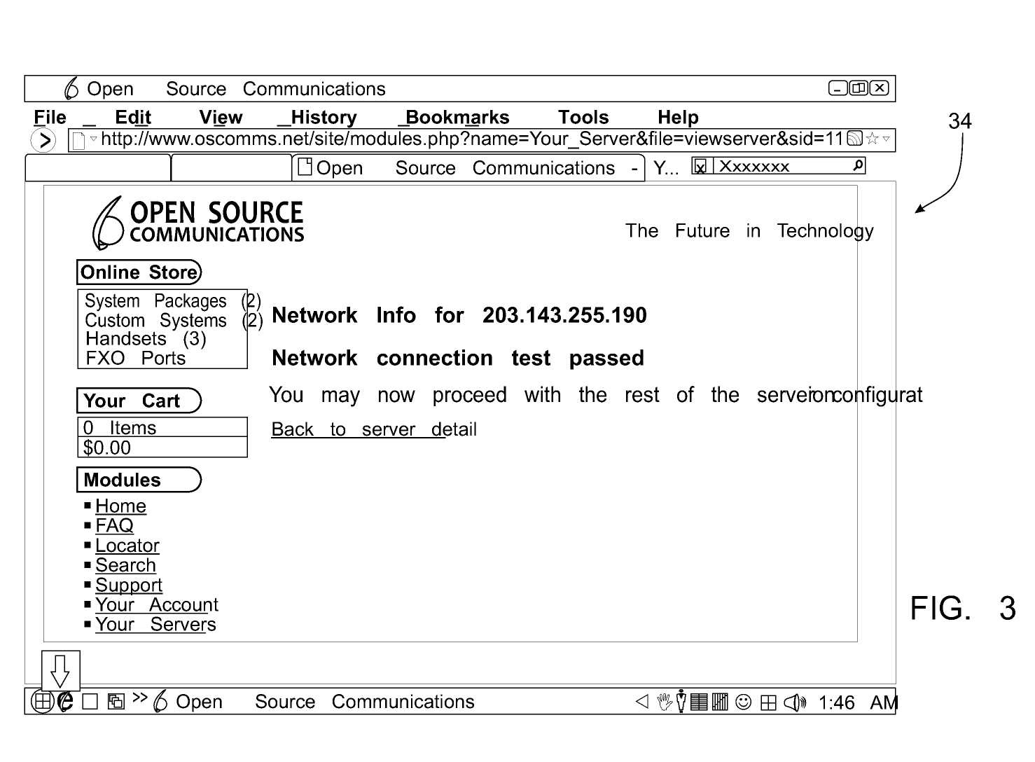

FIG. 3 is an illustration of a screen shot of a web page that is displayed when the check network test is successfully completed. The user then clicks “Back to server detail” and is directed back to the sever details page illustrated in FIG. 2. The user then clicks on the “Factory Reset” link shown in FIG. 2.

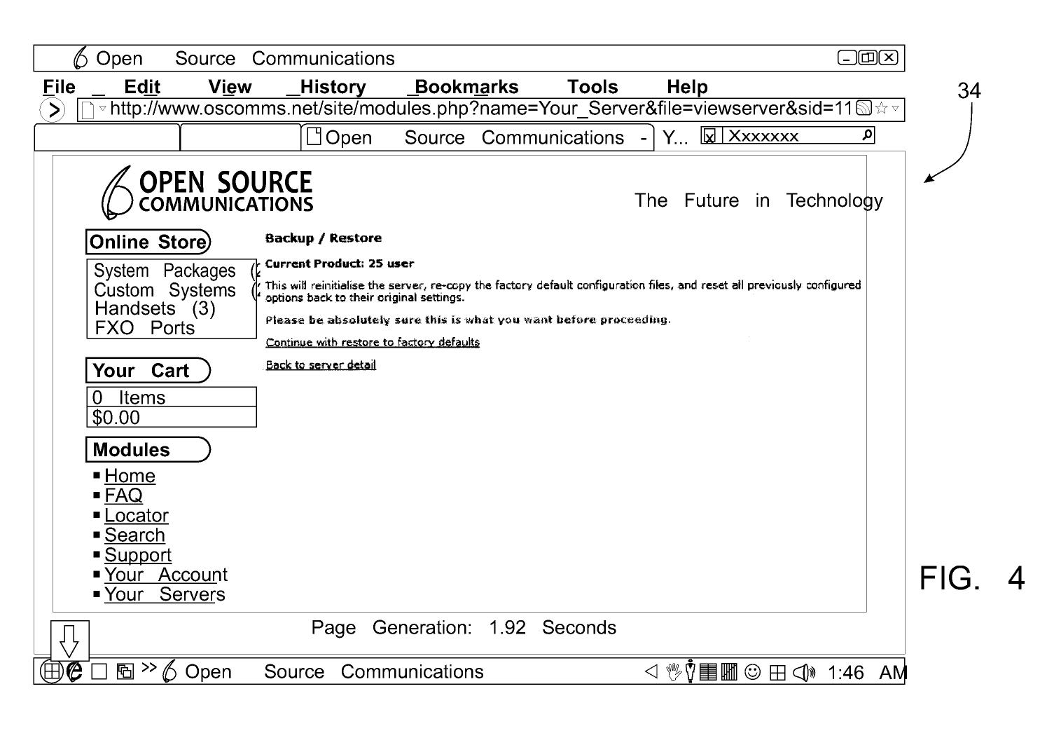

FIG. 4 is an illustration of a screen shot of a Backup/Restore web page, which is displayed after the user clicks on the “Factory Reset” link. The user/administrator then clicks on “Continue with restore to factory defaults”.

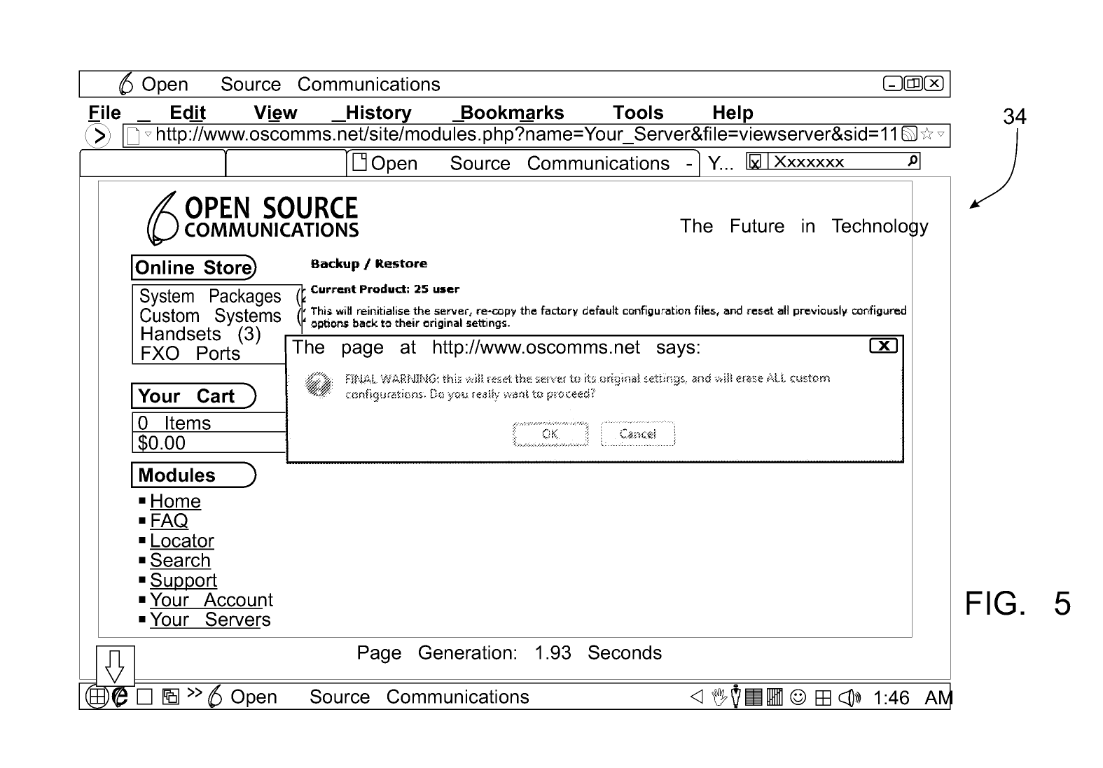

FIG. 5 is an illustration of a screen shot of a dialog box that is displayed after the user/administrator clicks on “Continue with restore to factory defaults.” The dialog box thus functions as a final warning that the VOIP PBX server 12 is about to be reset to its original settings and all custom configurations will be erased. Selecting “OK” results in restoration of the factory defaults. After several minutes the user/administrator is returned to the Backup/Restore web page shown in FIG. 4, and is able to navigate back to the Server Details page by selecting “Back to server detail.” The user then selects “Configure Business Plan”.

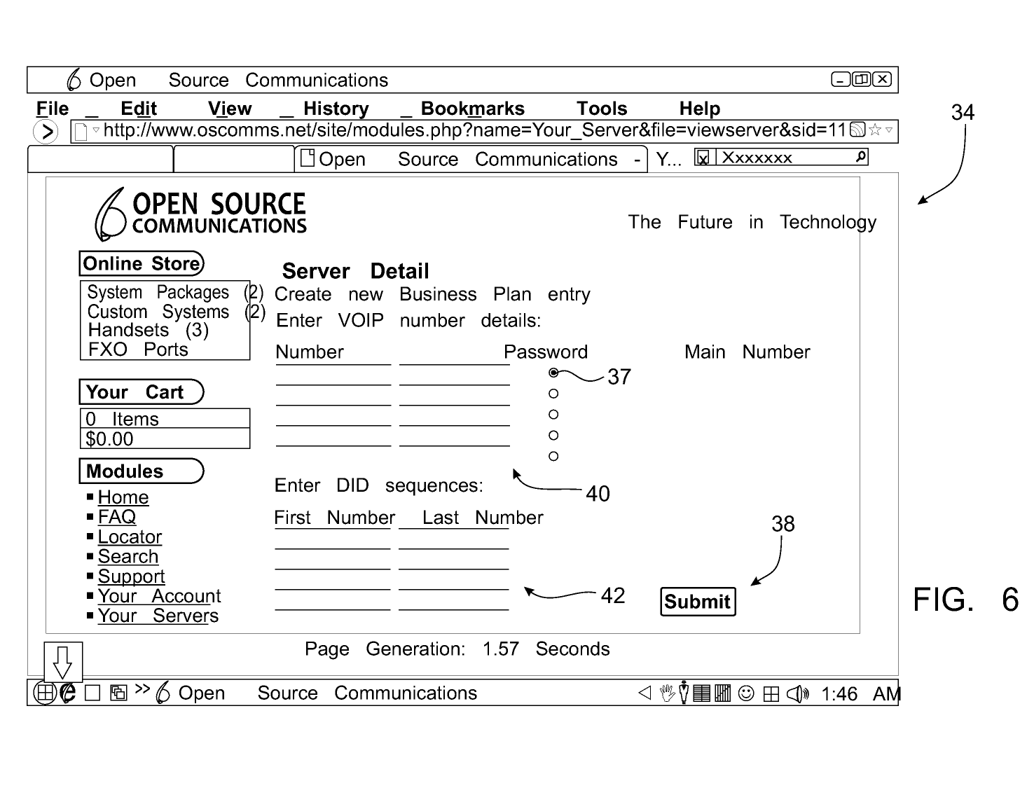

FIG. 6 is an illustration of a screen shot of a New Business Plan Entry web page used to receive new business plan data. Fields on the page are filled in by the user/administrator based on data provided by a VOIP provider. A radio button 37 is used to identify a main number to which direct in-dial numbers are attached. After relevant data are entered in VOIPer number configuration fields 40 and DID sequence configuration fields 42, the user/administrator clicks on a submit button 38.

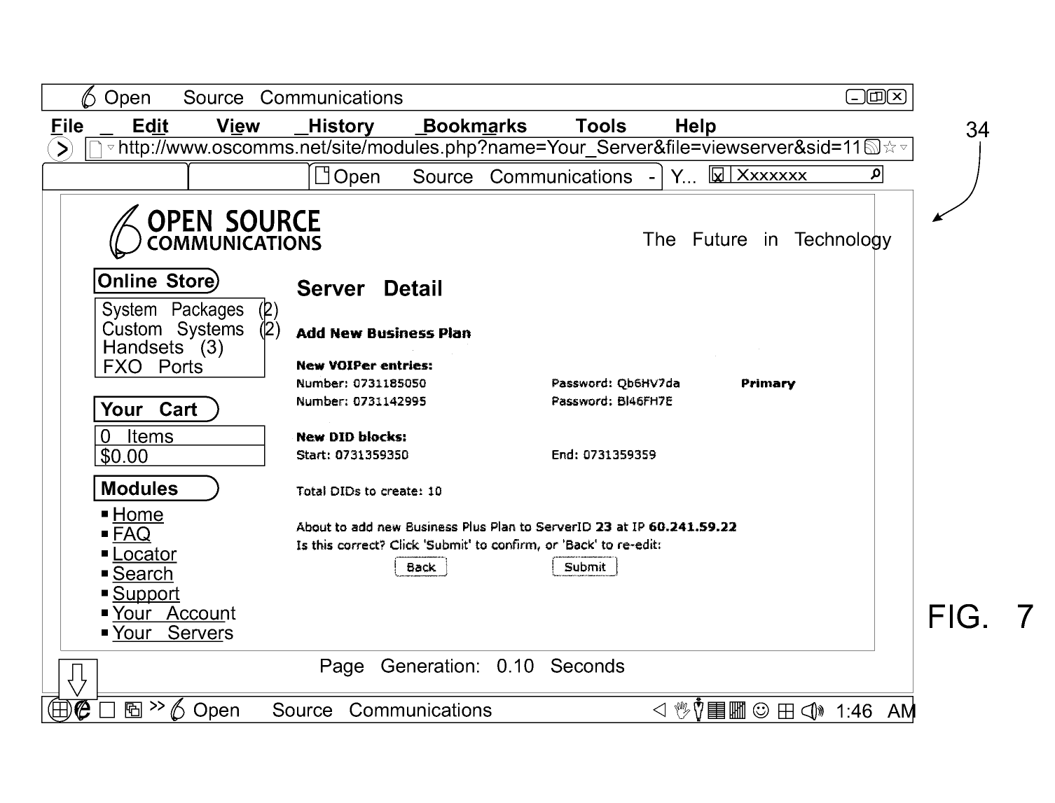

FIG. 7 is an illustration of a screen shot of a Server Detail web page that is displayed after the submit button 38 is clicked on the New Business Plan Entry web page. The user/administrator is prompted to confirm that a new business plan should be added to a particular server identification at a particular IP address. After such confirmation, the Server Details page shown in FIG. 2 is again displayed to the user/administrator. The user/administrator then clicks on the “Detect Handsets” link.

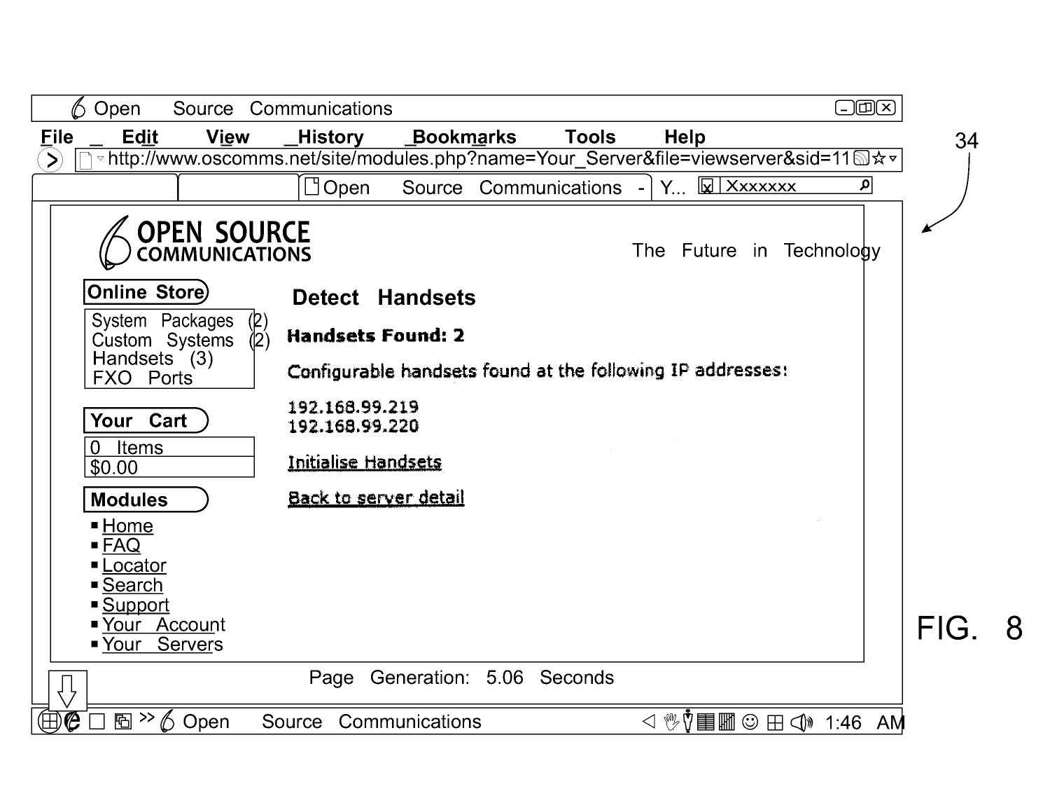

FIG. 8 is an illustration of a screen shot of a Detect Handsets web page, which is displayed after the user/administrator clicks on the “Detect Handsets” link illustrated in FIG. 2. The user/administrator clicks on the “Initialise Handsets” link. That resets the configuration of all handsets 18 included in the VOIP PBX system 10. The user/administrator then may be prompted with a warning to confirm that all handsets 18 should be reset.

Handset detection may include the following:
1. Confirm that an Ethernet interface to a handset switch is up (normally eth1).
2. Generate a netmask from an IP address (default is 192.168.99.2, this means the handset network can include handsets identified by the following IP addresses: 192.168.99.3 through 192.168.99.254).
3. Scan the handset network for IP addresses with open ports 80 and 5060. That is completed by compiling a list of “up” hosts using “ping”, then trying a connection to port 5060, and finally to port 80. Any host which responds ‘yes’ to all three of these tests must be a VOIP device.
4. Scan the address resolution protocol (ARP) table and compile lists by manufacturer. For example, every SNOM handset has a medium access control (MAC) address that begins 00:04:13.
5. For each manufacturer handset list, check for a configuration script. Associate each detected handset with a configuration script. If no configuration script is found for a specific manufacturer, remove the device from the master list.
6. Assign extensions to the list; inject extension numbers into script defined in step 5.
7. Send handset configuration script to the client host over a secure connection, and signal the client host to run the script.

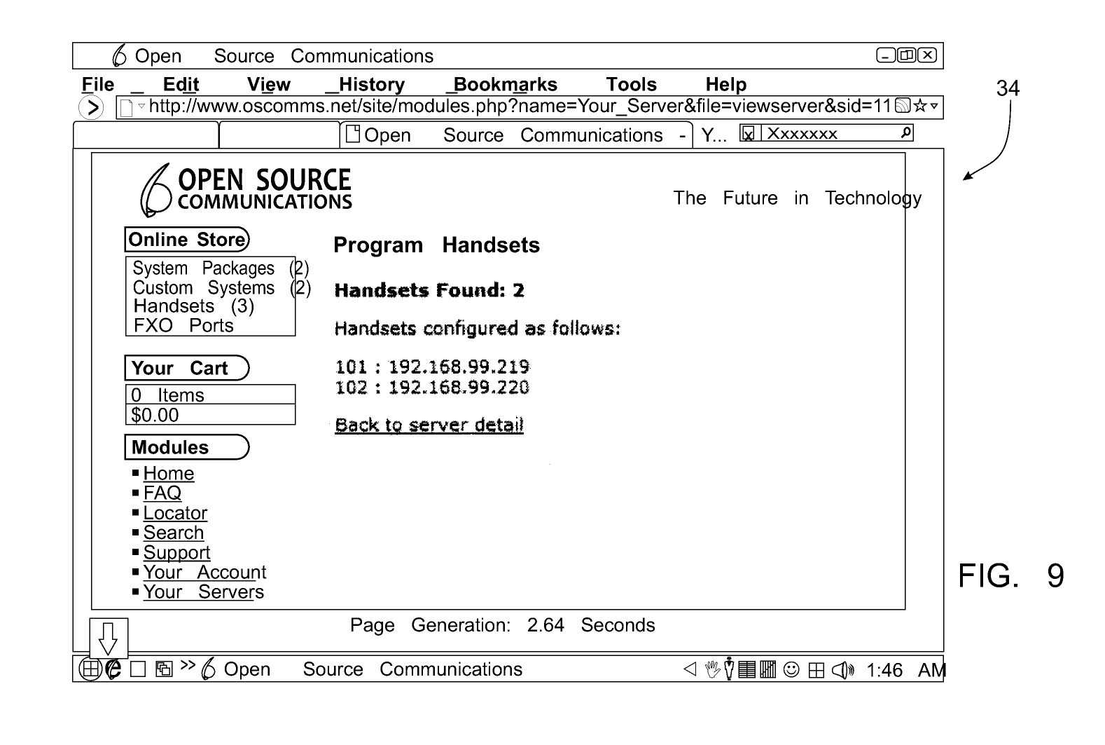

FIG. 9 is an illustration of a screen shot of a Program Handsets web page, which is displayed after the handsets 18 have been reconfigured. As shown, a first handset 18 having IP address 192.168.99.219 is assigned extension number 101, and a second handset 18 having IP address 192.168.99.220 is assigned extension number 102.

As illustrated in FIG. 6, configuration fields presented on the New Business Plan entry web page 34 include the VOIPer number configuration fields 40 for VOIP numbers and the DID sequence configuration fields 42 for a Direct Inward Dialling (DID) sequence. The configuration fields 40 for VOIP numbers include fields for number and password, as well as a tick box for indicating the main number. The configuration fields 42 for Direct Inward Dialling (DID) sequences include fields for the first number and last number in a DID sequence and provide for a number of DID sequences. As known by those having ordinary skill in the art, DID numbers enable organisations to have fewer external lines than extensions, while still having a unique number for each extension.

After the user submits configuration details via the New Business Plan entry web page 34, the central server 32 performs the following:
1. Integrity check of parameters:
   a. Are all required fields 40, 42 completed?
   b. Does the DID range make sense (e.g., positive number of DIDs)?
   c. Is a ‘Main Number’ indicated?
   d. Does every VOIP number have a password?
2. Load the appropriate template out of the database of templates for the VOIP PBX server 12 software version. The software version for each client system is stored in a memory of the central server 32, and is displayed/queried at the “server detail” web page.
3. Build the command list 36 in the form of a command list to be passed to the VOIP PBX server 12. The template gives a base configuration to be modified as will be discussed in more detail below.
4. Check that the VOIP PBX server 12 is live by completing a ‘ping’ test and an ‘open-port-80’ test. If both tests are successfully completed, the VOIP PBX server 12 is deemed ready to accept commands. If either test fails, the central server 32 informs the administrator of the error.
5. Queue the command list 36 to be passed to the VOIP PBX server 12.
6. Transmit the command list 36 from the central server 32 to the VOIP PBX server 12 in batch fashion over a secure HTTP connection. The command syntax used can be standard Unix shell script, or standard HTTP requests (e.g., http/1.0).

The command list 36 is completed by copying and filling in the configuration templates for each command. The configuration templates are defined in association with each VOIP provider, and require information about each provider's VoIP interface, for example:
1. Supported codecs (ulaw, alaw, gsm, g.729, etc);
2. Trunk type (SIP, IAX, etc);
3. Registration specification (heartbeat interval, timeouts);
4. Security information (secure/insecure registration channel);
5. Capacity (number of calls allowed on a channel, bandwidth limits); and
6. DID registration (whereby the call header DID information is transmitted).

Master configuration templates are stored in a database accessed by the central server 12, and are not modifiable. Each instance of configuring a VOIP PBX server 12 involves making a copy of master configuration templates and modifying the copies.

An example of a command list 36 is given below:
1./admin/config.php?type=setup&display=did&action=addIncoming&extension=073 1112345&answer=0&privacyman=0&goto0=custom&custom0=incoming-DID,s,1″;
2./admin/config.php?display=trunks&extdisplay=&action=addtrunk&tech=sip&outci d=&maxchans=&dialrules=&autopop=&npanxx=&dialoutprefix=&channelid=bp-5050&peerdetails=allow%3DULAW%2Calaw%2Cgsm%0D%0Aauth%3Dmd5%0D %0Acanreinvite%3Dno%0D%0Acontext%3Dfrom-pstn%0D%0Adtmfmode%3Dinband%0D%0Afromdomain%3Dvoice.mibroadband .com.au%0D%0Afromuser%3D0731112345%0D%0Ahost%3Dbyo.VoIPprovider. com.au%0D%0Ainsecure%3Dvery%0D%0Anat%3Dyes%0D%0Aport%3D5060% 0D%0Asecret%3passwordda%0D%0Atype%3Dfriend%0D%0Ausername%3D 0731185050&usercontext=0731185050&userconfig=context%3Dfrom-pstn%0D%0Asecret%3DQb6HV7da%0D%0Atype%3Duser&register=073111234 5%3AQb6HV7de%40VoIPprovidercom.au%2F0731112345&Submit.Submit+Ch anges”;
3. scp -o “StrictHostKeyChecking no”/home/moo/files/8/1233521381.txt root@192.168.99.2:/etc/asterisk/extensions_custom.conf;
4./admin/config.php?display=routing&extdisplay=001-9_outside&action=editroute&routename=001-9_outside&newroutename=&routepass=&dialpattern=XXXX.&npanxx=&repotrun kdirection=&repotrunkkey=&reporoutedirection=&reporoutekey=&trunkpriority %5B0%5D=OUT_{—}2&trunkpriority%5B1%5D=&Submit=Submit+Changes”;
5./admin/config.php?clk_reload=true&display=trunks&type=setup”.

Basic functions of a command list 36 are further described below:

Configure DID Range Redirector

1./admin/config.php?type=setup&display=did&action=addIncoming&extension=0731112345&answer=0&privacyman=0&goto0=custom&custom0=incoming-DID,s,1”

This command sets up a main redirector for a new DID range.

| Parameter | Use |
|---|---|
| Type = setup | Enter configuration mode |
| Display = did | Use ‘enter DID’ template |
| Action = addIncoming | Process as new DID rather than editing |
| | an existing DID |
| Extension = 0731112345 | DID delegated by VoIP provider |
| Answer = 0 | Do not answer using default routing method |
| Privacyman = 0 | Disable default privacy settings |
| Goto0 = custom | Set new DID to custom destination |
| Custom0 = incoming- | Process the new DID as a ‘DID redirector’. |
| DID, s, 1 | Jump to priority ‘s’, line ‘1’ of |
| | configuration. |

2. Create the new trunk

/admin/config.php

?display=trunks&extdisplay=&action=addtrunk&tech=sip&outcid=&maxchans=&dialrules=&autopop=&npanxx=&dialoutprefix=&channelid=bp-5050&peerdetails=allow%3Dulaw%2Ca

law%2Cgsm%0D%0Aauth%3Dmd5%0D%0Acanreinvite%3Dno%0D%0Acont ext%3Dfrom-pstn%0D%0Adtmfmode%3Dinband%0D%0Afromdomain%3Dvoice.VoIPprovider.com.au%0D%0Afromuser%3D0731112345%0D%0Ahost%3DVoIPprovider.com.au%0D%0Ai nsecure%3Dvery%0D%0Anat%3Dyes%0D%0Aport%3D5060%0D%0Asecret%3password%0D%0Atype%3Dfriend%0D%0Ausername %3D0731112345&usercontext=073111 2345&userconfig=context%3Dfrom-pstn%0D%0Asecret%3password%0D%0Atype%3Duser&register=0731112345%3AQb 6HV7da%40VoIPprovidercom.au%2F0731112345&Submit=Submit+Changes”

This command structures an Asterisk®< >VoIP provider interface—i.e., an interface that details how the new VoIP trunk will be used with a new Business Plan. Asterisk® is a telephony engine and tool kit released as open source code under the GNU General Public License (GPL). As defined by its developers, Asterisk® can be configured as the core of an IP or hybrid PBX, switching calls, managing routes, enabling features, and connecting callers with the outside world over IP, analog (POTS), and digital (T1/E1) connections. Asterisk® runs on a wide variety of operating systems including Linux, Mac OS X, OpenBSD, FreeBSD and Sun Solaris and provides features generally included in a PBX.

| Parameter | Use |
|---|---|
| Display = trunks | Use ‘enter trunks’ template |
| Action = addtrunk | Process a new trunk rather than edit an |
| | existing trunk |
| Channelid = bp-5050 | Label for the new trunk |
| Allow = ulaw, alaw, gsm | Specify preferred codec order |
| Dtmfmode = inband | Send DTMF codes with normal audio channel |
| Fromdomain = | Specify VoIP provider template to use |
| Insecure = very | Always treat trunk data as insecure (i.e., |
| | not encrypted) |
| Nat = yes | Allow NAT between client and VoIP provider |
| Port = 5060 | Specify TCP port to use |
| Fromuser = | VoIP login name |
| Username = | |
| Secret = xxxxx | VoIP password |
| Context = from-pstn | Calls arriving on this trunk are always external |

The last item in this command is the ‘registration string’. This is what Asterisk® uses to register with the VoIP provider.

register=0731112345:password@VoIPprovider.com.au/0731112345

The above code is separate from the username/password, and is used for both incoming and outgoing calls on a trunk. It is also used for ‘keepalive’—i.e., details used by a client system to provide a regular heartbeat to the VoIP provider.

3. Map extensions to DIDs

scp/home/moo/files/xxx/1233521381.txt root@xxx.xxx.xxx.xxx;/etc/asterisk/extensions_custom.conf

This command takes a different form from the others in the list, as it does not use an HTTP request. It passes a new configuration file from the central server 32 to the VOIP PBX server 12. This is because the DID mapping files do not exist by default, and the FreePBX interface does not support their modification. For this reason, backups of DID mappings are stored centrally rather than locally.

A DID mapping consists of two entries—a header filter, and a recipe for what to do when a DID is called. These are further defined as follows:

Header Filter

exten=>s,11,Gotolf($[“${Var_TO}”=“<sip:0712345678@VoIPprovidercom.au>”]?extension101,s,1)

This line is inserted into the default Asterisk® dialplan (i.e., the dialplan supplied with a normal Asterisk® install). Put simply, this searches the session initiation protocol (SIP) header at the Var_TO field. If a DID is matched, the program jumps out of the present processing loop and jumps to the ‘extension101’ procedure. Header filters are also defined by templates on a per-provider basis.

DID Recipe

[extension101]

exten=>s,1,Dial(SIP/102,15,t)

exten=>s,2,VoiceMail(102)

exten=>s,3,Hangup

exten=>s,102.VoiceMail(102)

exten=>s,103,Hangup

This is a reduced version of a normal Asterisk® dialpan for an extension. If a DID is called, the extension in question (in this case, 102) is called and rings for 15 seconds. If the extension is not answered or is busy/disconnected, a failover to Voicemail is processed for that extension. Once Voicemail is complete, the connection is hung up.

Configuration File

According to the present mapping function a configuration file is also generated and includes all of the above entries for a specific Business Plan, and is copied to the client system. The file does not exist in the standard Asterisk® distribution, so the file is created manually (it is then subsequently activated during the Business Plan Creation process).

When a Business Plan is created, DID mapping entries are created in sequence—i.e., extension 101 gets the first DID, extension 102 gets the second, and so on. If more than one DID range is specified, the process is simply repeated until all extensions have a DID mapping.

### Route External Calls

/admin/config.php?display=routing&extdisplay=001-9_outside&action=editroute&routename=001-9_outside&newroutename=&routepass=&dialpattern=XXXX.&npanxx=&repotrunkdirection=&repotrunkkey=&reporoutedirection=&reporoutekey=&trunkpriority%05B0%5D=OUT_{—}2&trunkpriority%5B1%5D=&Submit.Submit+Changes”

| Parameter | Use |
|---|---|
| Type = setup | Enter configuration mode |
| Display = routing | Use ‘outbound routing’ template |
| Action = editroute | Process as new route |
| Dialpattern = XXXX. | Use route for all non-internal calls |
| Trunkpriority = OUT_2 | Direct outgoing calls to first VoIP-based trunk |

Apply Changes

/admin/config.php

?clk_reload=true&display=trunks&type=setup” This command simply commits all the pending changes to the VOIP PBX server 12. This uses the FreePBX interface ('clk_reload) to regenerate all the configuration files of the VOIP PBX server 12, as well as the configuration database.

| Parameter | Use |
|---|---|
| Type = setup | Enter ‘setup’ mode |
| Display = trunks | Unused in this context |
| Clk_reload = true | Apply all pending changes to server |

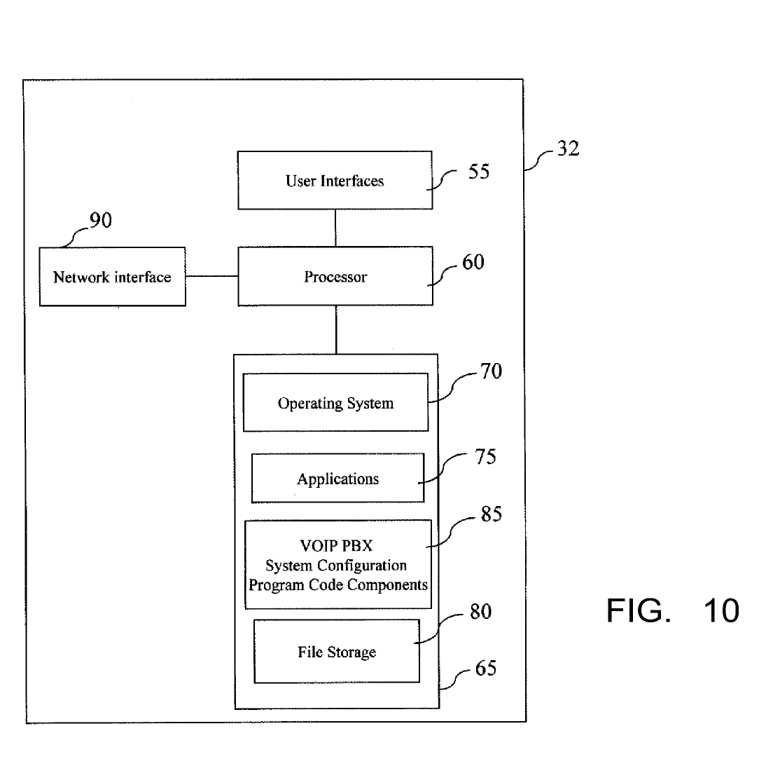

Referring to FIG. 10, a block diagram illustrates components of a central server 32 that can configure a VOIP PBX server 12, according to some embodiments of the present invention. The central server 12 comprises user interfaces 55 operatively coupled to at least one processor 60. A memory 65 is also operatively coupled to the processor 60. The memory 65 has storage sufficient for an operating system 70, applications 75 and general file storage 80. The general file storage 80 can function, for example, as a memory for storing VOIP PBX system configuration details as described herein. The user interfaces 55 can be a combination of user interfaces including, for example, but not limited to a keypad and a graphical user interface (GUI) such as a computer display screen. A network interface card 90 enables the central server 32 to be operatively coupled to an electronic communication network such as the Internet. It is to be understood that FIG. 10 is for illustrative purposes only and includes only some components of the central server 32, in accordance with some embodiments of the present invention, and is not intended to be a complete schematic diagram of the various components and connections between components required for all devices that may implement various embodiments of the present invention.

The memory 65 also includes computer readable program code components 85 concerning configuring a VOIP PBX system. When the computer readable program code components 85 are processed by the processor 60, the components 85 are configured to cause execution of a method for configuring a VOIP PBX system, such as the VOIP PBX system 10 as described above, according to some embodiments of the present invention.

Advantages of the present invention thus include enabling a system and method for remotely configuring and managing VOIP PBX system components from a remote central server. A VOIP PBX system thus can be accurately, efficiently and quickly configured based on an expert analysis of the system deployed from the central server. System backups also can be programmed and performed automatically and remotely. Further, security risks are reduced as all configuration communications are routed from the secure central server, rather than through various generic websites.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

What is claimed is:

1. A VOIP PBX configuration system for remotely configuring a VOIP PBX server connected to the internet, the VOIP PBX configuration system comprising:
a central server connected to the internet and having a database of VOIP PBX configuration templates, the central server being accessible via a website user interface having configuration fields to be populated by a user;
the central server including computer readable program code components configured to:
modify the configuration templates to generate configuration instructions based on user entries in the configuration fields; and
transmit the configuration instructions to the VOIP PBX server to configure the VOIP PBX server based on the user entries.

2. The VOIP PBX configuration system of claim 1, wherein the configuration fields include any one of the following: VOIP main number and password, and Direct Inward Dialling Number sequence.

3. The VOIP PBX configuration system of claim 1, wherein the configuration instructions are in the form of a command list which is built from one of the templates and the user entries in the configuration fields.

4. The VOIP PBX configuration system of claim 3, wherein the central server is operable to test that the VOIP PBX server is live before the command list is transmitted to the VOIP PBX server.

5. The VOIP PBX configuration system of claim 1, wherein the configuration fields include more than one VOIP number.

6. A method for remotely configuring a VOIP PBX server, the method comprising:
receiving at a central server connected to the internet user entries in configuration fields for configuring the VOIP PBX server;
modifying VOIP PBX configuration templates based on the user entries in the configuration fields to generate configuration instructions; and
transmitting the configuration instructions to the VOIP PBX server to configure the VOIP PBX server based on the user entries.

7. The method of claim 6, wherein the configuration fields include any one of the following: VOIP main number and password, and Direct Inward Dialling Number sequence.

8. The method of claim 6, wherein the configuration instructions are in the form of a command list which is built from one of the templates and the user entries in the configuration fields.

9. The method of claim 8, wherein the central server tests that the VOIP PBX server is live before the command list is transmitted to the VOIP PBX server.

10. The method of claim 6, wherein the configuration fields include more than one VOIP number.
